(19) United States
(12) Patent Application Publication
(10) Pub. No.: US 2019/0092043 A1
(43) Pub. Date: Mar. 28, 2019

(54) METHOD AND DEVICE FOR DIGITALLY PRINTING ON THREE-DIMENSIONAL OBJECTS

(71) Applicant: Dekron GmbH, Kelkheim (DE)

(72) Inventor: Thomas Schnitger, Eisenach (DE)

(21) Appl. No.: 16/094,215

(22) PCT Filed: Apr. 18, 2017
(86) PCT No.: PCT/EP2017/059126

§ 371 Date: Oct. 17, 2018

(30) Foreign Application Priority Data
Apr. 18, 2016 (DE) 10 2016 107 087.4

(51) Int. Cl. B41J 3/407; B41J 29/38

(52) U.S. Cl. CPC B41J 3/4073; B41J 29/38

(57) ABSTRACT

A method for digitally printing on three-dimensional objects comprising bottles, cans or other hollow bodies, by at least one printing head, includes breaking down a printing template into a multiplicity of printing dots. The printing dots are stored in a printing raster consisting of image columns and image rows. The printing raster is used for activating the at least one printing head during a printing process in which one of the objects to be printed moves relative to the at least one printing bead in order to apply a print image onto the object to be printed. The printing raster Is curved and the image rows and the image columns extend obliquely to one another. The printing template is read into the curved printing raster.

### CROSS-REFERENCE TO PRIOR APPLICATIONS

This application is a U.S. National Stage Application under 35 U.S.C. § 371 of International Application No. PCT/EP2017/059126 filed on Apr. 18, 2017, and claims benefit to German Patent Application No. DE 10 2016 107 087.4 filed on Apr. 18, 2016. The International Application was published in German on Oct. 26, 2017 as WO 2017/182439 A1 under PCT Article 21(2).

### FIELD

The invention pertains to a method for digitally printing on three-dimensional objects, particularly bottles, cans or other hollow bodies, by means of at least one printing head, wherein the object to be printed moves, particularly rotates, relative to the printing head for the printing process, wherein a printing template is broken down into a multiplicity of printing dots (pixels), preferably in a digitizing step, and the printing dots are stored in a printing raster consisting of image columns and image rows, and wherein the printing raster is used for activating the printing head during the printing process in order to apply a print image onto the object to be printed.

### BACKGROUND

In digital printing methods, the print image is directly transferred from a computer into a printing machine without the use of a static printing form. These methods particularly include ink jet printing, in which small droplets of ink are selectively ejected from the nozzles of the print head onto the surface to be printed in order to produce a print image thereon.

In order to determine the positions, at which the individual ink droplets are ejected onto the object to be printed, the image to be printed (image or printing template) is initially rasterized. Rasterizing is a software-assisted process, in which the printing template is “converted” into printing data. The core element is “Raster Image Processing.” The term rasterization is based on breaking down an image into discrete image elements (pixels) with defined spacings. A screen-like printing raster with raster cells or sections is used for this purpose. The corresponding color information of the respective discrete image element is stored for the respective cell.

The rasterization results in raster graphics consisting of a raster-shaped arrangement of image elements.

In order to generate a printing raster from a printing template, the printing template can be optically scanned, for example by means of a scanner, and divided or broken down into image elements. In other methods known from the prior art, computer-generated graphics (for example vector graphics) are directly converted into raster graphics. The coordinates assigned to the image elements and the color information stored for the respective coordinates are fed to the program control for the printing nozzles of the printing head in order to produce the print image.

Rasterizing is also referred to as image scanning and can be described to the effect that a virtual raster consisting of rows and columns is placed over the printing template and the color values (intensity values) in the individual raster cells are stored together with the associated raster coordinates (row Xᵢ, column Yⱼ). In this process, the printing template is respectively read into the raster or printing raster. The result is a matrix with color information stored in the cells.

The printing template is usually scanned based on a two-dimensional, Cartesian coordinate system (Cartesian image raster). Such a coordinate system is formed by two orthogonal axes X and Y and has a grid-like structure with rectangular cells. The resolution of the image is defined by the size of the raster cells. For example, the spacing between two horizontal raster lines defines the print resolution in the vertical direction. The spacing between two vertical raster lines defines the print resolution in the horizontal direction. A so-called quantization takes place in a subsequent step. The term quantization refers to the evaluation of an image element, i.e. the brightness (intensity) and, if applicable, the color shade of a pixel, based on a defined grayscale or color quantity in the individual raster cells. The color information is stored together with the associated coordinate of the raster (row Xᵢ, column Yⱼ).

The digital image data serves for activating the printing head. The printing head sequentially moves to the raster coordinates of the print image and produces printing dots at the locations predefined by the printing raster in accordance with the color information stored for the respective printing dot (e.g. quantity, color). The result is a print image that consists of image elements arranged in a raster-shaped manner.

The printing head comprises at least one printing nozzle, but multiple printing nozzles are typically arranged adjacent to one another in a nozzle row, wherein the nozzle row extends in the direction of the printing head width. A printing head that comprises only one nozzle row is referred to as a single-row printing head. In this case, the spacing between the two outermost nozzles of the row defines the effective printing head width. In a uniform arrangement in a row, the individual printing nozzles are respectively arranged offset to one another in the direction of the row by one nozzle spacing. The native printing head resolution of the single-row printing head along the printing head width is defined by the nozzle spacing.

It is also common practice to arrange multiple nozzle rows adjacent to one another, wherein the nozzle rows extend parallel to one another and respectively comprise the same number of nozzles (multi-row printing head). In this case, the printing nozzles of a second row are offset relative to the printing nozzles of the first row in the direction of the printing head width, namely by half the nozzle spacing in a two-row printing head. In a two-row printing head, the native printing head resolution in the direction of the printing head width can therefore be doubled in comparison with a single-row printing head with the same nozzle spacing.

All printing dots of a row of the printing raster are typically printed by the same nozzle that moves relative to the surface to be printed parallel to one of the printing raster axes. However, if the print motif is wider than the effective printing head width, the image has to be divided into sections and printed in parts. In this case, a first image part is initially printed and a second image part, which is offset to the first image part, is subsequently printed.

However, this procedure has the disadvantage that the seam between these two partial images, which are also referred to as print segments, can be easily recognized. In order to solve this problem, a method referred to as “stitching” is frequently used. In this case, the print segments/partial images of two successive printing steps no longer flushly border on one another, but rather overlap in an overlapping region. Two partial images are therefore not simply printed flushly adjacent to one another in their entirety in two successive printing steps. Instead, the printing required for obtaining the desired image is only partially carried out in the overlapping region in the first printing step. The missing part of the print image is completed in the subsequent second printing step. The image parts outside the transition areas are printed in one step. The image quality is enhanced because the borders between the print segments produced in successive printing steps cannot be recognized as easily due to the overlapping region.

Although stitching reduces the effective useful length of the printing head, this is gladly accepted because the image quality can be enhanced. However, this method requires an interruption of the printing process in order to displace the object to be printed into a second printing position. This procedure is therefore referred to as successive cyclic application of image parts. However, tolerance-related errors may occur in this case, wherein these errors can be attributed, among other things, to the displacement of the object to be printed. This can be elucidated in that the printing dots are at a print resolution of 720 dpi (1 dpi=1 dot per inch) spaced apart from one another by only about 3/100 mm. Servomotors known from the prior art have a tolerance of 1/100 mm, which can also be referred to as resolution. This means that the seam may deviate from the preceding print image by 1/100 mm, i.e. by 33% of the printing dot spacing. This can also be perceived by an untrained eye because it is capable of recognizing position deviations of a few micrometers. Such an offset particularly can also be easily recognized because the seam for the stitching is identical for all printing inks in order to utilize the maximum printing width and all inks therefore have the same offset problem at the same location. Furthermore, the effect of gravity becomes noticeable when printing with vertically arranged printing heads. A vacuum of approximately 10 mbar typically prevails in the individual nozzle chambers in order to prevent an inadvertent escape of ink from the printing nozzles. The nowadays typical printing head width of about 70 mm therefore leads to a pressure difference of 7 mbar between a top and a bottom printing nozzle of a printing head with multiple printing nozzles if the printing nozzles are arranged vertically on top of one another. Consequently, the droplet volume is no longer uniform during the printing process. The lower printing nozzles with the higher internal pressure (corresponding to the lower vacuum) eject a slightly larger droplet than the upper nozzles with a lower internal pressure. This manifests itself in the color intensity because more ink is applied in an area printed by the lower printing nozzles than in an area printed by the upper printing nozzles. This is particularly noticeable if droplets of the lower and the upper printing nozzles border on one another due to stitching. This intensifies the impression of an optical error for the viewer.

DE 35 26 769 A1 describes a method for printing on containers, in which the container rotates in front of the printing head and is moved in the direction of his rotational axis. In this case, the individual ink dots are applied along parallel helical lines. An interruption of the printing process is therefore no longer required. However, the printing result may be impaired due to the relative motions when the printing head applies the individual inks in accordance with the values in the printing raster. The nozzles or nozzle heads are offset to one another in the direction of the longitudinal container axis and therefore do not lie in one plane.

Stitching may also be carried out in such a helical printing process. However, this stitching does not extend horizontally as in the sectional printing process, but rather follows the helical motion. Consequently, an offset of the printing heads as described in DE 35 26 796 A1 once again results in the stitching region being identical for all inks and therefore easily recognizable.

### SUMMARY

In an embodiment, the present invention provides a method for digitally printing on three-dimensional objects including bottles, cans or other hollow bodies, by at least one printing head. A printing template is broken down into a multiplicity of printing dots. The printing dots are stored in a printing raster consisting of image columns and image rows. The printing raster is used for activating the at least one printing head during a printing process in which an object to be printed moves relative to the at least one printing head in order to apply a print image onto the object to be printed. The printing raster is curved and the image rows and the image columns extend obliquely to one another. The printing template is read into the curved printing raster.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically shows printing on a rotationally symmetrical container according to a first embodiment of the invention; and

FIGS. 2a-e schematically show rasterizing of an image motif according to another embodiment of the invention.

### DETAILED DESCRIPTION

Embodiments of the present invention enhance the quality of digitally printed images on three-dimensional objects.

Embodiments of the present invention allow seamless printing of infinite image lengths on three-dimensional objects without having to break down the printing process into individual work cycles. An aspect, according to an embodiment of the invention is that the printing raster, which serves for activating the printing head during the printing process and into which the printing template is read, is not rectangular, but rather curved or distorted, and that the image rows and the image columns or the X-axis and the Y-axis do not extend perpendicularly, but rather obliquely to one another. The printing raster is therefore an oblique raster.

In the oblique raster, the rows and columns or the X-axis and the Y-axis do not extend orthogonally to one another, but rather at an angle, for example, of less than 90°. The curvature of the printing raster can be compared with a distortion of a Cartesian coordinate system. A regular rectangular printing raster can be distorted by shifting one of opposite sides of a rectangle by a certain distance (offset/shift) such that a parallelogram with corresponding parallelogram-shaped raster cells is formed. In the process, the sides bordering on the side being shifted carry out a pivoting motion like in a parallelogram linkage. The printing raster or the individual printing raster cells may also have the shape of a rhombus, which represents a special type of parallelogram.

The curved printing raster serves for activating the printing head just like a regular printing raster. For example, the printing head successively moves along the image rows (X-direction) and applies the print medium for each image element to the object in accordance with the information stored for the image element in the raster cell (Xᵢ, Yⱼ). However, reading the printing template into the curved printing raster makes it possible to enhance the printing result as the printing head carries out a motion relative to the object to be printed.

According to another embodiment of the invention, the printing raster or the printing raster cells respectively have the shape of a parallelogram or a rhombus.

The curved printing raster is particularly advantageous if the printing head carries out multiaxial motions relative to the object to be printed. Distortions of the print image can already be prevented and compensated beforehand by using a distorted raster for digitizing the printing template. It is ensured that each printing head nozzle sets the correct printing dot on the surface to be printed. Another embodiment of the invention proposes that the object to be printed or the surface to be printed not only moves along or about an axis relative to one or multiple printing heads, e.g. rotates relative thereto, but rather carries out a compound multiaxial motion relative to the printing head. The printing head may naturally also carry out a multiaxial motion about the object to be printed.

Compound multiaxial motions take place along and about individual or multiple axes. They can also be referred to as superimposed motions. This means that they are not mere translatory or mere rotatory motions, but particularly combinations of a relative displacement and a relative rotation during printing. The term “printing” refers to the process, in which the printing head applies the print medium onto the surface to be printed. During printing, the object to be printed may be displaced along a first axis while simultaneously rotating about one or more rotational axes. The rotational axis may naturally coincide with the first displacement axis. However, the proposed method can basically also be applied to a one-dimensional relative motion between the printing head and the object.

According to another embodiment of the invention, the motion of the object to be printed is a helical motion along and about an axis. According to the invention, it is therefore proposed that the object rotates in front of the printing head and is simultaneously moved along its rotational axis while it is printed by the printing head. For example, the displacement relative to the printing head may take place upward or downward. Due to the helical motion, the image is divided into oblique stripes that are seamlessly joined to one another and make it possible to produce a complete print image without interruption or repositioning of the object. In this way, the error resulting from repositioning the printing head during sectional printing is avoided and the quality of the stitching is significantly enhanced.

If the printing dot raster corresponds to a parallelogram raster, the X-axis virtually extends about the object in a helical manner, wherein the printing head is guided relative to the object along a helical path. The printing raster can be virtually placed on the outer side of the container/object, on which it helically extends about the container. The relative motion of the printing head follows the printing raster or extends along the printing raster and the printing head applies the print medium in accordance with the information on the corresponding printing raster cell.

Due to the curved raster and the helical motion, it is no longer necessary to divide or break down the print image into individual print segments, which are successively printed on the surface by displacing the object between two image sections with an additional motion in order to further print the object after a subsequent standstill. Instead, the printing process can take place continuously. This leads to a clearly superior print image.

According to an embodiment of the invention, the print medium can be applied in a multi-pass or single-pass process. In a multi-pass process, each row/printing raster cell or section to be printed is applied multiple times, wherein a pattern or image is built up in multiple steps. In other words, the print medium for the printing raster cell is applied in multiple passes or steps. However, multi-pass printing also makes it possible to produce a print image, the resolution of which is higher than the native resolution of the printing head by setting additional dots between dots that were already set. In the single-pass process, the print image is printed in only one printing process and the printing head therefore does not have to be moved over the surface to be printed for a second time.

According to another embodiment of the invention, different inks are simultaneously applied onto the surface of the object to be printed without intermediate curing between individual inks. Multicolor printing is a technique for producing colored printed products. The most frequently used type of multicolor printing is four-color printing with the standardized primary colors cyan, magenta, yellow and black (CMYK), i.e. the process inks ejected onto the object through the nozzles of the printing head. In this context, it is particularly preferred that the 4 printing nozzles for the primary colors CMYK are activated simultaneously and thereby allow immediate curing after the application of the print image.

Another embodiment of the invention provides that at least individual printing dots of the print image are applied in multiple steps, wherein the distribution of the overall quantity of the print medium for the individual printing dots over the individual steps takes place in a randomly controlled manner. The determination of the print medium quantity to be applied for the printing dot may be realized with a random generator. Alternatively, it is also possible to use an algorithm that distributes the quantity of the print medium over the individual steps. In this context, it is in certain circumstances possible that one or more of the aforementioned printing nozzles used for printing the printing dot cell do not apply any print medium at all onto the printing dot cell. The randomly controlled or algorithm-controlled distribution of the print medium quantity over the individual steps can basically be used in all printing methods, in which printing dots are applied in multiple partial steps. The irregular, non-constant distribution of the print medium application over multiple steps reduces the perceptibility of errors caused by the failure or malfunction of nozzles or by positioning inaccuracies. The risk of recognizing transitions or print segment borders is particularly reduced. According to the invention, the algorithm may be configured for taking into account the failure of a printing nozzle in that this printing nozzle is deactivated and the other printing nozzles to be used for printing the printing dot respectively compensate this deactivation. To this end, the intended print medium quantity of the failed nozzle can be distributed over the remaining nozzles. In this way, the maintenance intervals of machines can be extended.

In order to achieve an optimal and economical utilization of the printing head capacity in a single-pass process, another embodiment of the invention proposes that, during a helical relative motion between a single-row printing head and the object, the length of the motion or the displacement along the rotational axis per revolution of the object (in the following referred to as pitch) corresponds to the product resulting from the number of nozzles of the printing head multiplied by the nozzle spacing. The extent of the printing nozzle arrangement is therefore used as a pitch dimension for the continuously applied print area. The print image raster is thereby optimally adapted to the motion and the resolution of the printing head. In this case, the printing nozzles do not pass over any region of the print area more than once (single-pass process).

Regardless of the diameter of an object, particularly a rotationally symmetrical object, that is printed continuously due to a relative helical motion, the print image always finds its seam after one revolution and the curved or parallelogram-shaped printing raster also ensures an optimal print image during such a multidimensional relative motion.

In this case, the curved printing raster for a single-row printing head with n printing nozzles, which are respectively arranged offset by one nozzle spacing in the direction of the row, is preferably formed of a rectangular printing raster in that the rectangular printing raster is distorted into a parallelogram or a rhombus, wherein the distortion correlates with n-times the nozzle spacing.

In order to carry out color printing in a single-pass printing system, multiple printing head modules or printing heads may be mounted behind one another or adjacent to one another in the moving direction of the print area being guided past the printing heads, e.g. in the form of a helical motion relative to the printing heads. In this case, one primary color, particularly cyan, magenta, yellow and, if applicable, black, is respectively assigned to the printing head modules. Printing head modules with a special color may be added for exceptional printing applications.

According to an embodiment of the invention, however, the pitch may also be reduced by a factor or a fixed value such that an overlap of the print images is produced after one revolution, wherein the width of said overlap results from the reduction of the pitch. The greater the reduction of the pitch, the greater the overlap. Transitions between the applications by different nozzles can be blurred by means of the overlap. For example, an overlap can be used for blurring a transition on a border between applications by an upper and a lower nozzle after a 360° rotation. During the subsequent rotation, printing dots that overlap in the overlapping region can be distributed over the individual partial print images of the overlapping region in accordance with an algorithm or by means of a random generator. In this stitching-like method, the distribution of the ink quantity does not follow a fixed pattern.

It is advantageous, particularly for multi-pass processes, if the motion or displacement of the object along the rotational axis is in accordance with another embodiment directly related to the resolution of the print image and the printing nozzle density in the displacement direction. According to the invention, at least individual printing dots of the print image are applied in multiple steps, wherein the pitch (axial offset per revolution) used for the helical motion in a multi-pass process corresponds to the number of nozzles multiplied by the nozzle spacing and divided by the number of steps.

It is likewise possible that only some of the printing nozzles are used. According to the invention, it is proposed, e.g., that only every second printing nozzle of the printing head is used. Since the printing helix only has half the pitch in comparison with “single-pass” processes, twice as many revolutions are in fact required for the same height of the print area, but half the printing nozzles can remain deactivated in order to achieve the same printing density. During two successive revolutions, it is particularly advantageous to use the printing nozzles, which were not used during the prior revolution, during the subsequent revolution and to now deactivate the previously used half of the printing nozzles (alternating nozzle use). In this way, positioning inaccuracies and nozzle errors are not perceived as easily.

The use of only some of the printing nozzles of the printing head (for example 100 of 1000) is also advantageous when printing on objects with a very small diameter. The ratio between the printing helix pitch and the circumference of the object can thereby be adapted to a given desired vertical printing density.

Another embodiment of the invention proposes that the relative speed, with which the printing head and the object move relative to one another, is respectively changed or varied during the printing process. It is particularly proposed that the object carries out a helical motion relative to the printing head during printing and that the pitch of the helical motion is varied during the printing process. In other words, the length, by which the object is during printing displaced along its rotational axis during one revolution of the object, can vary. This allows printing on objects that have complex shapes and/or printing of special image designs. The variation of the pitch makes it possible, for example, to react to variations in the outside diameter of a container such that a uniform print image is produced.

According to an advantageous embodiment of the invention, the resolution can also be varied with the change of the pitch. The print image or an area of the print image particularly can be applied with a resolution that is higher than the native resolution of the printing head. In this case, the pitch (axial offset per revolution) used while printing the area for the helical motion corresponds to the number of nozzles multiplied by the nozzle spacing and divided by the number of a multiple of the native resolution.

However, another embodiment of the invention provides that the printing head or the printing heads are aligned in such a way that the nozzle arrangement extends in a direction parallel to the relative rotational axis. In a printing machine, the printing nozzles may be arranged underneath one another, i.e. vertically. Due to gravitation, this vertical arrangement causes the print medium filled into the printing head to be ejected from the lower nozzle with a higher pressure than from the upper nozzle. This typically results in different droplet sizes that manifest themselves in the color intensity. Seams would become visible in cyclic height-offset printing. This effect is even more distinct when printing with multiple inks because this applies to all inks. The seam effect is prevented with the inventive method because no horizontal row is formed on the one hand and because each ink can in multicolor printing be applied at a different location on the other hand. In multicolor printing, in particular, the application of different inks, preferably each of the inks, can respectively begin at different locations of the object to be printed. The printing nozzles for different inks, particularly all inks, therefore respectively begin with the ink application at locations that are spatially offset to one another. This is particularly the case if a helical relative motion takes place between the printing head and the object. Due to the helical relative motion, the inks are effectively distributed and do not occur at the same location as it is the case in seam printing. This particularly applies to instances, e.g., in which the bottom nozzles of multiple printing heads are respectively located at the same height, especially when the printing heads are arranged annularly around a cylindrical body. In this case, the helical seams of the different inks do not extend on the same row at a simultaneous printing start of the printing heads, but rather are offset to one another. In 4-color printing, the seam of each ink is thereby masked by 3 other inks because their seams respectively lie at a different location. It is proposed that the printing template read into the printing raster preferably is respectively modified for a first printing head and/or a second printing head in such a way that the printing starts of the different printing heads on the object to be printed are offset to one another. The printing start for both printing heads therefore does not lie at the start of the print image on the object to be printed. The printing start of the second printing head particularly may be offset relative to the printing start of the first printing head by an angle referred to a rotational axis, about which the object to be printed is rotated. The second printing head subsequently prints the omitted starting area of the print image such that 360° printing can once again be realized. This is possible, for example, once the object to be printed has been additionally rotated relative to the second printing head and the starting area, which was initially omitted by the second printing head, lies in front of the second [sic] printing head. In order to offset the printing start of the first printing head and the second printing head on the object to be printed relative to one another, it generally suffices to modify the printing template read into the printing raster for the first printing head or the second printing head only.

It is particularly preferred that an area of the printing template read into the printing raster, which should initially not be printed, is cut off for the first printing head and/or for the second printing head or the second printing head and attached to a previous end of the printing template read into the printing raster. In this way, a continuous 360° image without a jump from the end at 360° to the beginning at 0° is once again formed for the corresponding printing head.

This is explained in greater detail with reference to an example. If the second printing head, e.g. for the color magenta, is offset relative to the first printing head, e.g. for the color cyan, by 90° referred to the rotational axis, the original printing template read into the printing raster can be modified for the second printing head, in this example for the color magenta, as follows: in the printing template read into the printing raster, a starting area, which corresponds to 0° to 90° of the print image to be applied referred to the rotational axis, is cut off the printing template read into the printing raster for the second printing head. In order to ensure that the modified printing template once again extends from 0° to 360°, the non-cut area is on the one hand displaced toward the start by 90° and the area that was cut off is on the other hand attached to an end of the non-cut area. The starting area, which was previously cut off, now forms an area from 270° to 360° of the printing template for the second printing head. After this modification, the information for the second printing head is cyclically shifted relative to the information for the first printing head by an angle of 90°. In a manner of speaking, the printing template for the second printing head, in this case for the color magenta, is “phase-shifted” relative to the printing template for the first printing head, in this case for the color blue. Due to this modification, in particular, the first printing head and the second printing head can be arranged at the same height referred to the rotational axis and nevertheless simultaneously start printing on the object. In this case, the printing start of the second printing head (in this example cyan) is offset relative to the printing start of the first printing head (in this example magenta) by 90° in order to achieve qualitatively enhanced stitching.

Furthermore, a printing start of a third printing head can preferably be offset relative to the printing start of the second printing head by an angle. This angle particularly may be identical to the angle, by which the printing start of the second printing head is offset relative to the printing start of the first printing head.

It is preferred that the printing template read into the printing raster is modified for the different printing heads in such a way that the printing starts of all printing heads on the object to be printed are respectively offset to one another.

In order to obtain a clean print image, it proved advantageous to place the printing start underneath the print image to be printed. The first printing dot is set as soon as the location of the object to be printed reaches the first nozzle of the printing head during its motion in the axial direction.

According to another embodiment of the invention, the object is rotated about a rotational axis during printing and the rotating direction is reversed during the printing process. In this way, the print area or individual regions of the print area can be printed with higher resolution. Alternatively or additionally, the object may be axially moved along an axis, preferably the rotational axis, and the moving direction along the axis may be reversed during the printing process. The reversal of the displacement or the rotation may takes place in the region of one or more printing heads. This approach particularly has time-saving implications in multi-pass processes.

Another embodiment of the invention provides that pinning and/or curing of the ink takes place during the printing process and/or after printing. The applied print image particularly may be pinned and/or cured during or between or after the individual ink applications. After the application of the print medium (e.g. ink or other color mediums), the object can be cured with corresponding means. These include, e.g., radiation sources such as a UV lamp, chemical means such as cross-linking or curing components or heat sources for evaporating the liquid components. The object may furthermore rotate about a rotational axis during curing, wherein the rotating direction can also be reversed during the curing process.

The invention also pertains to a device for digitally printing on three-dimensional objects, particularly bottles, cans or other hollow bodies, wherein said device is designed for carrying out one of the methods described herein. According to the invention, such a device comprises a receptacle for the object to be printed, at least one drive unit, by means of which the receptacle can be axially displaced in a displacement direction and rotated about a rotational axis in a rotating direction, at least two printing heads and a control for activating the drive unit and the printing heads. The control is designed in such a way that it displaces the receptacle with the object arranged thereon in the displacement direction, as well as rotates said receptacle in the rotating direction, during printing. The receptacle may be a mounting, preferably a rotary table or the like, which particularly moves the object in the form of a compound multiaxial motion.

In multicolor printing, at least two printing heads are positioned at the same height in the displacement direction. They therefore lie in one plane and have no axial offset. However, they are offset in the circumferential direction about the rotational axis.

The at least two printing heads lying in one plane preferably start to print simultaneously. The oblique strips, which the printing heads print onto the object to be printed during the helical printing process and helically extend around the object to be printed, then do not lie on top of one another in a precisely fitted manner. Instead, they are offset relative to one another, namely also after one complete revolution and multiple revolutions of the object to be printed. The strip edges of a first oblique strip of the first printing head therefore lie within the at least one second oblique strip of the second printing head and are thereby masked. In this way, the print image becomes sharper and its quality is very high. The print image particularly is less affected by irregularities in the shape of the object to be printed.

The device may be designed for controlling the multiaxial motion of the object in such a way that an area to be printed can be printed by all printing heads during the printing process. To this end, for example, the positions of the printing heads may be chosen in dependence on the axial offset per revolution such that the printing heads can respectively start to print at the same axial height of the object.

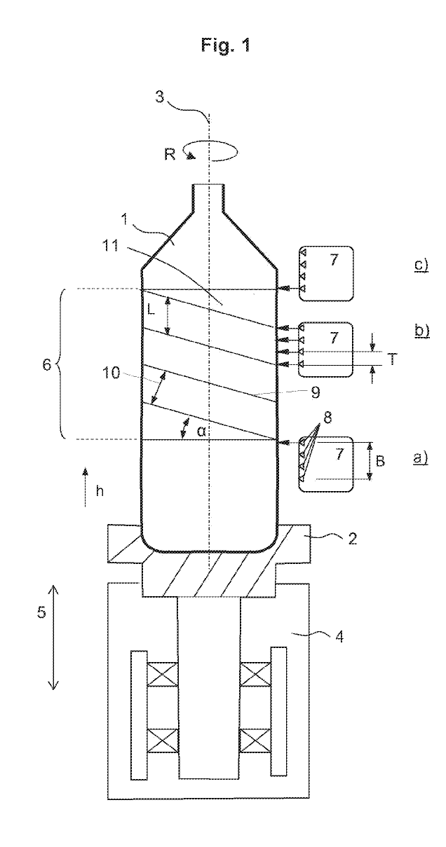

FIG. 1 shows a rotationally symmetrical, three-dimensional object 1 to be printed in the form of a bottle. The bottle 1 is accommodated in a receptacle 2 in the form of a rotary table, wherein the rotary table 2 can be driven in a rotatory manner about a rotational axis 3 such that the bottle 2 rotates about its symmetry axis or center axis, which coincides with the rotational axis 3 in the longitudinal direction (in this case in the vertical direction). The rotary table 2 forms part of a drive unit 4 that is only illustrated schematically and can be displaced in the vertical direction, i.e. upward and downward along the rotational axis 3, as indicated with arrows 5.

An area 6, onto which a print image should be printed, is marked on the outer side of the bottle 1 and extends around the outer circumference of the bottle 1. A printing head 7 is arranged adjacent to the bottle 1. Different vertical positions of the printing head 7 relative to the bottle 1 are indicated with a), b) and c). However, these positions concern the same printing head in different phases of the printing process.

The printing head 7 comprises a multiplicity of printing, nozzles 8, the arrangement of which extends in the vertical direction (displacement direction) along the extent B. Neighboring (directly adjacent) nozzles of a nozzle row extending parallel to the axis 3 have a spacing T. The printing nozzle row is aligned vertically and parallel to the axis 3. The extent of the print region 6 or the print area in the axial direction (in the vertical direction) is greater than that of the nozzle arrangement B.

The image to be printed is available in digital form and broken down into a virtual raster of image elements, which consists of image columns and image rows, by means of software known from the prior art. The printing raster serves for activating the printing nozzles. Ink is applied onto the bottle 1 in the form of printing dots from the nozzles 8 according to the information on the printing dot raster by means of droplet application such that the print motif is printed onto the outer side of the bottle 1 in the form of a raster motif.

The bottle 1 is held such that the area 6 to be printed is slightly spaced apart from the printing head 7 and respectively rotates about its center axis or about the rotational axis 3 along the rotating direction R. This rotatory motion is paired with a displacement motion 5 along the rotational axis 3 (in this case downward) such that the printing head 7 moves upward relative to the object 1. Consequently, this concerns a compound or superimposed multiaxial motion that combines an axial motion and a rotatory motion. As a result, the area 6 to be printed moves past the printing head 7 in a helical manner. The motion particularly concerns a relative motion in the form of a helical line. This may also be referred to as a printing helix.

In this way, the printing head 7 is moved relative to the bottle 1 from the opposition a) to the position b) and ultimately to the position c). Printing starts once the first (top) nozzle 8 of the printing head 7 reaches the first image element of the bottom row of the printing dot raster at the position a). The following printing dots for the lower edge of the printing dot raster are printed by the top nozzle 8 until the second nozzle from the top reaches the lower edge of the print area. Starting at this point, the second nozzle also prints a helical line that lies underneath the helical line of the first nozzle. After a certain displacement of the printing head, the bottom nozzle also enters the print area. Starting at this point, an oblique print strip 10 is printed onto the bottle such that it helically extends around the bottle. The oblique continuous lines 9 in FIG. 1 indicate the printing sequence of the print strip 10 applied onto the front side 11 of the bottle 1 by the printing head 7. The oblique print strip 10 respectively transforms into the strip printed during the preceding revolution in a seamless manner such that a seamless and clean print image is obtained.

The pitch, i.e. the relative displacement h between the printing head 7 and the bottle 1 in the axial direction per revolution of the bottle 1 about the rotational axis 3, results from the sum of the extent B of the nozzle arrangement 8 and the spacing T between the nozzles 8 (h=B+T). In this way, a helical print strip 10 with an axial width L, which corresponds to the extent B, is continuously printed onto the outer side of the bottle 1.

In position c), the printing head 7 has almost exited the print area, wherein the bottom nozzle of the printing head 7 in this case applies the final droplets in accordance with programming.

In the context of the invention, the above-described method can also be carried out the other way around in that the bottle is moved upward in the axial direction during printing. In this case, printing starts on the upper edge of the area 6 to be printed.

In addition, the pitch can also be cut in half in that the distance of the relative displacement per revolution is cut in half. In this way, intermediate dots can also be set such that the printing resolution is increased.

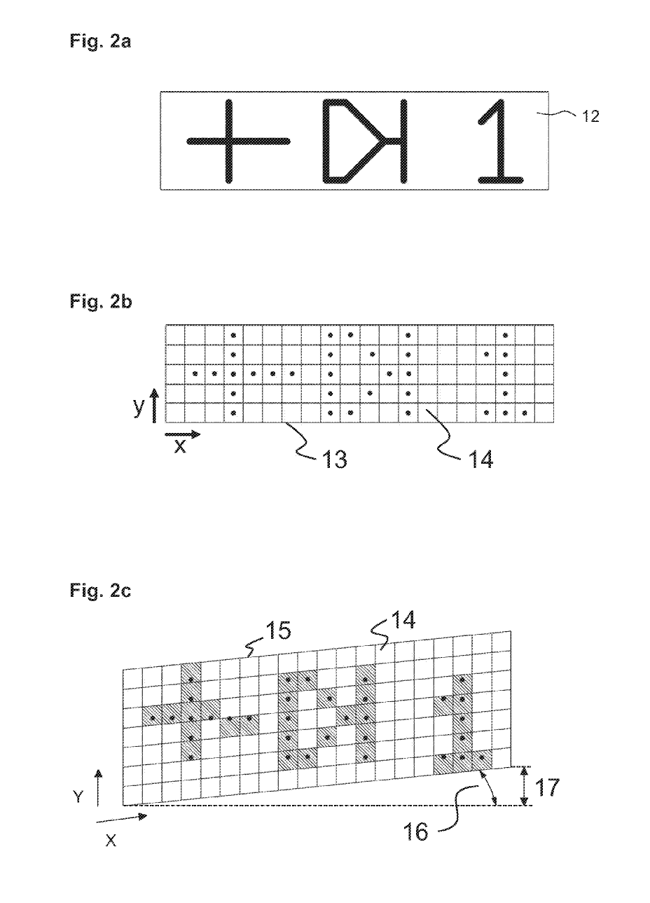

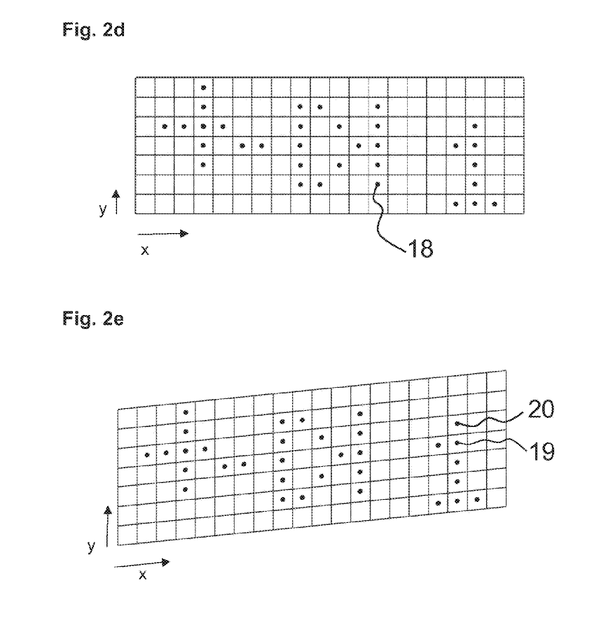

FIG. 2a shows an analog print motif (printing template 12). This image motif is rasterized for the raster printing process.

According to FIG. 2b, a virtual Cartesian raster 13 is placed over the image motif. The raster 13 is realized in the form of an X-Y raster and divided into individual raster cells 14. The raster cells 14 are rectangular. The color information of the print motif is read into the individual raster cells and stored in the raster cells. The printing template is now available in rasterized form. During the printing process, the printing head virtually scans the printing raster and prints the individual image elements in accordance with the information stored for the individual image elements in the raster.

Analogous to FIG. 2b, FIG. 2c shows the rasterization of the motif 12 according to FIG. 2a into a printing raster 15. However, the printing raster 15 is not a Cartesian raster with rectangular cells, but rather a non-orthogonal two-dimensional raster, in which the coordinate axes X, Y do not extend perpendicular to one another, but obliquely at an angle 16.

In order to produce the printing raster 15, the Cartesian raster 13 illustrated in FIG. 2b can be virtually distorted before the print motif is read in by shifting one of the axes X or Y. In the example shown, the axis Y was shifted by a distance 17. As a result, the entire raster was distorted like a parallelogram linkage. The previously rectangular cells 14 of the raster now have the shape of a parallelogram.

The parallelogram 15 is sufficiently large for completely including the analog image motif when it is virtually placed thereon. Analogous to the Cartesian raster 13, the image area is divided into image area columns and image area rows by vertical raster lines (parallel to the Y-axis) and oblique raster lines (parallel to the X-axis). In this context, the size of an image element, which at 720 dpi amounts to 0.03×0.03 mm, has to be considered. A horizontal line would therefore become slightly stepped just as an oblique line in the Cartesian raster. In return, the oblique line in the parallelogram raster is printed more precisely. When a horizontal line in the parallelogram raster is printed, the deviation corresponds to no more than the spacing between 2 nozzles (in our example 1/100 mm) and therefore cannot be perceived by the human eye.

In the present example, the parallelogram 15, which is placed over the print motif, is arranged relative to the Cartesian raster 13 in such a way that the Y-raster lines of the parallelogram 15 extend parallel to the Y-raster lines of the Cartesian raster 13 whereas the X-raster lines of the two rasters 12, 15 extend obliquely to one another. In other words, it is basically possible to distort a raster used for rasterizing a print motif and to read the image data into the raster.

During the rasterization, the image motif is divided into individual parallelograms 14 (image area cells) by the oblique (X) and vertical (Y) raster lines and the corresponding color information is stored in the raster 15.

During printing, the image information in the raster cells 14 is read out at the raster positions (image column Xᵢ and image row Yⱼ) and used for controlling the printing head. With respect to the printing data, the parallelogram raster is processed like a Cartesian raster.

FIG. 2d shows the printing result 18 (raster-like print image) when the parallelogram raster 15 is processed in the form of a Cartesian raster, wherein the printing head is moved parallel to the X-axis and no relative motion between the printing head and the surface to be printed takes place in the Y-direction. The print motif is printed on in a respectively inclined or oblique manner.

FIG. 2e shows the printing result 19 (raster-like print image) of a combined rotatory and displacement motion of the object 1 to be printed relative to the printing head 7 when the parallelogram raster 15 according to FIG. 2c is used for controlling the printing head 7. During the application of the image, the displacement of the surface to be printed is superimposed with the rotatory motion. This results in a printing helix pitch a of the rows printed by the individual printing nozzles per revolution (see FIG. 1). The printing helix pitch a respectively correlates with or corresponds to the pitch angle 16 of the printing raster 15. Due to the printing helix pitch a, the bottle is—according to the preceding definition of the pitch—displaced by the distance h after one revolution. The print motif according to FIG. 2e approximately is inversely transformed and the individual printing dots 20 are applied in accordance with the desired result.

The required consideration of the motion of the body to be printed relative to the printing head along the rotational axis of the body to be printed took place during the generation of the printing data from the image motif 12 by means of the Y-axis of the raster, which is inclined by the printing helix pitch α.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE LIST

1 Object to be printed (bottle)

2 Receptacle (rotary table)

3 Rotational axis

4 Drive unit

5 Displacement direction

6 Area to be printed (print area)

7 Printing head

8 Printing nozzles

9 Printing sequence

10 Print strip

11 Front side

12 Printing template (image motif)

13 Cartesian raster

14 Printing raster

15 Raster cell

16 Angle

17 Displacement

18 Print image (printing result)

19 Print image (printing result)

20 Printing dots

B Extent of printing nozzles

L Strip width

R Rotating direction

T Nozzle spacing between adjacent printing nozzles of a nozzle row

h Displacement

α Printing helix pitch

1: A method for digitally printing on three-dimensional objects including bottles, cans or other hollow bodies, by at least one printing head, the method apprising:
breaking down a printing template into a multiplicity of printing dots;
storing the printing dots in a printing raster consisting of image columns and image rows; and
using the printing raster for activating the at least one printing head during a printing process in which an object to be printed moves relative at least one printing head in order to apply a print image onto the object to be printed,
wherein the printing raster is curved and the image rows and the image columns extend obliquely to one another, and wherein the printing template is read into the curved printing raster.

2: The method according to claim 1, wherein the printing raster has the shape of a parallelogram or a rhombus.

3: The method according to claim 1, wherein the printing head comprises one row of printing nozzles with n printing nozzles and a spacing between adjacent printing nozzles, wherein the curved printing raster is formed of a rectangular priming raster, wherein the rectangular printing raster is distorted into a parallelogram or a rhombus, and wherein the distortion correlates with n-times the spacing.

4: The method according to claim 1, wherein an area of the object to be printed is moved relative to the at least one printing head in the form of a composite multiaxial motion during the printing process.

5: The method according to claim 1, wherein the object to be printed is rotated relative to the at least one printing head and simultaneously moved along its rotational axis during the printing process such that the object carries out a helical motion relative to the at least one printing head.

6: The method according to claim 5, wherein a pitch of the helical motion for a single-pass printing process corresponds to a number of printing nozzles multiplied by a spacing between two adjacent printing nozzles.

7: The method according to claim 5, wherein individual ones of the printing dots of the print image are applied in a number steps, and wherein a pitch corresponds to a number of printing nozzles multiplied by a spacing between two adjacent nozzles and divided by the number of steps.

8: The method according to claim 5, wherein a pitch of the helical motion corresponds to a number of printing nozzles multiplied by a spacing between two adjacent printing nozzles and divided by a number of a multiple of the native resolution of the at least one printing head such that an area of the print image applied with a resolution which is higher than the native resolution of the at least one printing head.

9: The method according to claim 5, wherein pinning and/or curing of the ink takes place anting the printing process and/or alter the printing process.

10: The method according to claim 5, wherein a rotating direction of the object to be printed is reversible during the printing process and/or a process of curing the ink.

11: The method according to claim 5, wherein a pitch of the helical motion is varied during the printing process.

12: The method according to claim 1, wherein at least individual ones of the printing dots of the print image are applied in a number of steps, and wherein a distribution of an overall quantity of a print medium for the printing dots over the number of steps takes place in a randomly controlled manner.

13: The method according to claim 1, wherein the printing template read into the printing raster is respectively modified for a first printing head and/or a second printing head of the at least one printing head in such a way that the printing process starts with different printing heads on the object to be printed offset to one another.

14: The method according to claim 1, wherein an area of the printing template read into the printing raster, which should initially not be printed, is cut off for a first printing head and/or for a second printing head of the at least one printing head, and is attached to a previous end of the printing template read into the printing raster.

15: The method according to claim 1, wherein the at least one printing head includes first, second, third and fourth printing heads, and wherein a printing start of the third and/or the fourth printing head is offset relative to a printing start of the second printing head by an angle.

16: A device for digitally printing on three-dimensional objects including bottles, cans or other hollow bodies, by the method according to claim 1, the device comprising:
a receptacle for the object to be printed;
at least one drive by which the receptacle is axially displaceable in a displacement direction and rotatable about a rotational axis in a rotating direction;
at least two printing heads; and
a control configured to activate the at least one drive and the at least two printing heads, wherein the control is designed in such a way that the control displaces the receptacle with the object to be printed arranged thereon in the displacement direction, as well as rotates the receptacle in the rotating direction, during the printing process,
wherein the at least two printing heads are positioned at the same height in the displacement direction.

17: The device according to claim 16, wherein the control is designed in such a way that the at least two printing heads simultaneously start to print on the object to be printed.
